(19) United States
(12) Patent Application Publication
(10) Pub. No.: US 2008/0234146 A1
(43) Pub. Date: Sep. 25, 2008

(54) Proppant and Production Method Thereof

(76) Inventors: Evgeny Borisovich Barmatov, Sipachi (RU); Elena Mikhailovna Pershikova, Moscow (RU); Konstantin Mikhailovich Lyapunov, Novosibirsk (RU); Jonathan Abbott, Didcot (GB)

Correspondence Address: SCHLUMBERGER TECHNOLOGY CORPORATION;David Cate, IP DEPT., WELL STIMULATION, 110 SCHLUMBERGER DRIVE, MD1, SUGAR LAND, TX, 77478, US

(21) Appl. No.: 12/049,528

(22) Filed: Mar. 17, 2008

(30) Foreign Application Priority Data
Mar. 22, 2007 (RU) 2007105188

(51) Int. Cl. C09K 8/68

(52) U.S. Cl. 507/203

(57) ABSTRACT

The invention relates to the oil-and-gas production industry and can be used for enhancement of the production of oilfield wells as it prevents the fracture from closing by pumping of propping granules (proppant) during the hydraulic fracturing of oil-producing formations. Higher stimulation of a reservoir through using hydraulic fracturing is provided with the proppant as particulate with spherical or elliptic form, made of ceramic, polymer, metal, or glass and having higher roughness than regular proppant, wherein the surface roughness is nonuniform and described by two criteria A and B, varying in the intervals: A=0.0085−0.85; B=0.001−1.0. The proppant manufacturing method comprising the preparation of raw material, mixing, granulation, drying, firing, wherein an additional stage of creation of surface roughness is added at the granulation stage and/or the firing stage.

This application claims foreign priority benefits to Russian Patent Application No. 2007110505, filed on Mar. 22, 2007

### BACKGROUND

The statements in this section merely provide background information related to the present disclosure and may not constitute prior art.

The invention relates to the oil-and-gas production industry and can be used for enhancement of the production of oilfield wells as it prevents the fracture from closing by pumping of propping granules (proppants) during the hydraulic fracturing of oil-producing formations.

Presently, hydraulic fracturing is the most advanced stimulation method for hydrocarbon production. The essence of the hydraulic fracturing method is injection of a viscous fluid into oil-bearing and gas-bearing reservoir under high pressure, which results in growth of fractures open for fluid flow. To keep the fractures open, spherical granules (proppant) are delivered by the carrier fluid into the fracture and the proppant fills the fracture making a strong propping pack still permeable for formation fluid. Proppant particles are made strong enough to withstand a high formation pressure and resist the impact of a corrosive medium (moisture, acid gases, brine) at high temperatures. Quartz sand, bauxites, kaolines, alumina, as well as different silica-alumina types of the feedstock are used as raw materials for the production of proppants.

The sphericity and roundness of particles, as well as uniformity of their size and shape are important properties of proppants. The said properties are crucial for permeability of the proppant packs in the fracture and, consequently, for ability of hydrocarbon fluids to flow from the fracture surface through spaces in the proppant pack.

Presently, there are a number of known methods for considerable reduction in the flowback of proppant particulates or other propping agents out from the fracture.

The most commonly used approach is based on application of curable resin coated proppant, which is pumped into the fracture at the end of treatment. However, there are a number of considerable restrictions imposed on application of this type of proppant; these restrictions are caused by side chemical reactions between the resin coating and the fracturing fluid. On the one hand, this interaction results in partial degradation and disintegration of the resin coating, reducing the strength of adhesion between the proppant particles and, consequently, the strength of the proppant packing. On the other hand, the interaction between the resin coating components and the fracturing fluid leads to uncontrolled changes in the fluid rheology. This also reduces the efficiency of the hydraulic fracturing method. The above-listed factors, and cyclic loads during well completion and shutting-in of well (or long shut-in periods) may damage the strength of the proppant packing.

Also, there is a known method for mixing a solid proppant with a deformable material consisting of beaded particles. The deformable particles are made of a polymeric material. The shape of deformable polymeric particles may be different (oval, wedge-like, cubical, rod-like, cylindrical or conical), but with the maximum length-to-base aspect ratio preferably being less than or equal to 5. Spherical plastic beads or composite particles with solid core and a deformable coating may also serve as deformable particles. Usually, the volume of the non-deformable core is about 50 to 90 vol. % of the total volume of the particle. The solid core can be quartz, cristobalite, graphite, gypsum or talc.

In another embodiment, the proppant core consists of deformable materials and may include grinded or crushed materials, e.g., nutshell, shell of seeds, fruit pits and processed wood.

For securing propping agent and restricting it removal we may use mixture of proppant with adhesive polymer materials. Adhesive compositions make mechanical contact with particles of the propping agent, wrapping around and covering them with tackifying layer. That leads to tackifying between particles, and also with sand or crushed fragments of the propping agent, which leads to significant or total prevention of solid particles flowback. The tackifying compounds main remain tacky for a long time even at high temperatures avoiding cross-linking or curing.

Tackifying material can be combined with other chemicals regularly applied in the fracturing treatment, i.e., inhibitors, bactericide, polymer gel breakers, and also inhibitors of wax formation and corrosion.

In one known method for propping a fracture by using tackifying agents and resin coated proppants, proppant flowback control is achieved by delivering of tackifying coated particulate mixed with deformable particulates (the latter is already the effective tool for flowback control).

The known methods of proppant flowback control are costly in manufacturing, and difficult to make. Besides that, the use of the above mentioned materials for proppant flowback control, including the propping agents with curable resin coating, leads to a significant decrease in the permeability of proppant packs.

### SUMMARY OF THE INVENTION

The invention relates to compositions and methods for application in subterranean formations, particularly spherical or elliptic rough-surfaced proppant and the procedure of proppant delivery for proppant flowback control.

In a first embodiment, disclosed is a proppant material include a particulate with spherical or elliptic form, made of ceramic, polymer, metal, or glass and having higher roughness than regular proppant, where the surface roughness is nonuniform and described by two criteria A and B, varying in the intervals: A=0.0085−0.85; B=0.001−1.0.

In another aspect, the invention is a method for proppant manufacturing which includes preparing a raw material, mixing, granulation, drying, and/or firing, where an additional stage of creation of surface roughness is conducted at the granulation stage and/or the firing stage. Ceramic, polymer, metallic, glass, cement materials or mixtures thereof may be added to a pelletizer before the granulation stage. Powder, granules or fibers and their combinations, or various agglomerates of ceramic, polymer, metallic, glass, and cement powders and/or fibers and mixtures thereof may be used as raw material. The roughness-producing treatment may be carried out in several stages, thereby these stages may be intermitted by a powdering stage. The various forms of roughness and irregularities may be created at different stages after the granule growth stage.

The tackifying agent may be also used for higher adhesion between roughness particulate and the granule surface. The tackifying agent may be deposited as a thin layer on the granules before the roughness stage and/or it is mixed with particulate for inducing roughness.

In some embodiments, strengthening ceramic, glass, polymer, metallic, cement coating or mixture thereof is deposited on the particles before the firing stage. The firing stage may have a temperature high enough for partial flashing of ceramic surface and buckling of surface during the firing stage. In yet other embodiments, an additional layer is deposited on the granule with the melting temperature below the melting temperature of basic material of granule. Alternatively, the powdering of the semi-finished granule during the granulation stage may be carried out with a powder with the melting temperature below the melting temperature of basic material of granule.

The firing stage may be followed by adding of ceramic, polymeric, metallic, glass, cement powders and/or fibers or mixtures thereof. These materials may stick to proppant and create at least one form of roughness and irregularity.

### DESCRIPTION OF THE DRAWINGS

Certain embodiments of the invention will hereafter be described with reference to the accompanying drawing, wherein like reference numerals denote like elements, and:

FIG. 1 is cross-sectional view of a proppant granule having irregularities upon the surface, according to an embodiment of the present invention.

### DESCRIPTION OF THE INVENTION

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure.

The description and examples are presented solely for the purpose of illustrating the preferred embodiments of the invention and should not be construed as a limitation to the scope and applicability of the invention. While the compositions of the present invention are described herein as comprising certain materials, it should be understood that the composition could optionally comprise two or more chemically different materials. In addition, the composition can also comprise some components other than the ones already cited. In the summary of the invention and this detailed description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possession of the entire range and all points within the range.

The invention solves the formulated technical problem by offering the production method for spherical or elliptic rough-surfaced proppant and the procedure of proppant delivery for proppant flowback control.

The technical result of the present invention is a higher stimulation of a reservoir through using hydraulic fracturing.

This improvement in hydrofracturing is achieved by pumping of proppant with rough surface. The particulate is spherical or elliptic and made of ceramic, polymers, metal, or glass, with the surface roughness criteria A and B in the ranges: A=0.0085−0.85; B=0.001−1.0.

The criteria of the particle surface roughness are given by following formulas:

A=¹/_{D\sqrt{n}} (1)

B=^{h}/_{D} (2)

where n is the average number of irregularities per 1 mm² of proppant surface, h is the average height of irregularities, and D is the diameter of a proppant particle in case of spheroids or the length of the longer axis for elliptic, lamellated, cylindrical, tubular granules or other granules of non-spherical shape.

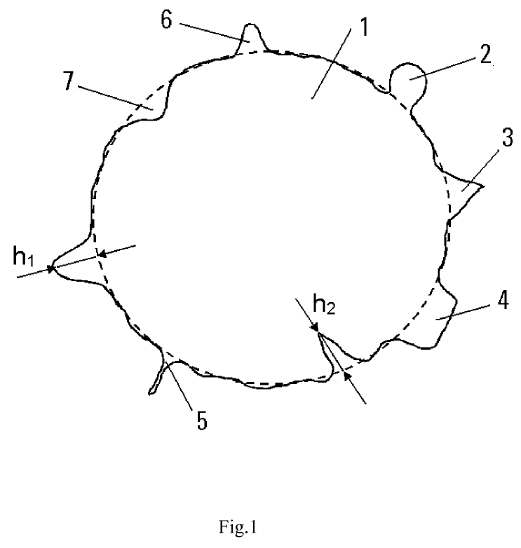

Parameter A describes the ratio of the average distance between the irregularities (in the shape of peaks and cavities—see FIG. 1) to the diameter of proppant granules in case of spheroids or to the length of the longer axis of elliptic and other granules with non-spherical shape.

Parameter B provides the ratio of the average height (or depth) of surface irregularities to the diameter of proppant granules in case of spheroids or to the length of the longer axis of elliptic and other granules with non-spherical shape.

Besides, one can use both the combinations of ceramic and polymer materials, and the introduction of glass and metallic components.

FIG. 1 shows the scheme of a proppant granule 1 section, having the irregularities upon the surface in the form of peaks 2-6 and cavities 7. Proppant granules might have peaks of the following types: sphere-shaped, elliptic or drop-like 2, pyramidal or conic 3, rectangular or trapezoidal 4, thread-like, thorn-like or lathlike 5, dome-shaped 6, and combinations thereof.

The distribution of peaks and cavities on the surface may be random or regular.

The irregularities 2-6 upon the surface of the proppant have the same hardness as proppant material 1 or have lower/higher hardness.

The proppant granule shape described in the invention provides a high resistance to the proppant flowback during well completion, cleaning, flushing, acid treatment and other treatments, as well as during production period of the well. The method efficiency is explained by development of mechanical bonds inside the proppant pack due to high friction between the granules and a partial matching of the peaks on the proppant surface to cavities on the surface of another proppant granule; this is also enhanced by compacting of proppant fines on the sites of proppant granules contact. A special case of interaction is partial penetration of the hard peaks (3, 5, 6) into the surface of adjacent proppant granules.

Even though the technology of the use of the suggested proppant is standard, the use of this type of proppant with rough surface increases dramatically the resistance to proppant flowback, keeping at the same time a high permeability of the proppant pack.

The method proposed allows using a propping material throughout the whole fracturing treatment or only at the final phase of the propping stage.

The standard proppant technology includes preparation of raw material, its mixing, granulation, drying, and firing. The extra-rough surface of the proppant granules, manufactured with the suggested method, is created during the granulation stage (granule nucleation or growth) and/or during the firing of proppant.

While manufacturing proppant with the offered technology, the choice of raw material is the same as for conventional technology. The primary raw materials are various bauxites, clays, kaolin, sintering additives, structure-forming components, and their combinations. Raw components are mixed by formula, then granulated, dried, fired and screened. However, now the development of roughness and irregularities is a controllable process at granulation and/or firing stages. Note that the proppant granulation might be performed either by dry or wet method.

According to one variant of method embodiment, ceramic, polymer, metallic, glass, binding materials and their combinations are added into the pelletizer during the powdering stage between the granule growth stage and granulation stage. This fine ceramic powdering is required to prevent the sticking and packing of unfinished proppant. Materials added are powder, pellets, fibers (or their combinations), or various agglomerates of ceramic, polymer, metallic, glass or binding powders and/or fibers, and also their combinations. Materials added on the powdering stage create at least one type of rough and bumpy surface, described by criteria 1 and 2 and depicted in the FIGURE. The amount of material, added at this intermediate stage, is calculated on the basis of the average number of irregularities upon 1 mm² of proppant surface, the average height and diameter of proppant in the case of spheroids. According to this method, the regular stages of ceramic proppant technology are applied after the granulation (drying, screening classification, firing, and final screening).

According to the second variant of the invention embodiment, additional coating stage is applied between the stage of shaping the elliptic, slated, cylindrical, tubular particles or other non-spherical particles and their combinations and the stage of surface powdering with fine ceramic powder control of raw particles caking. This additional coating is applied from the classes of ceramic, polymer, metallic, glass, binding materials, and also their compositions, thereby the materials are powders, granules or fibers (or their combinations), or various agglomerates of ceramic, polymer, metallic, glass or binding materials (powders and/or fibers), and their combinations. This additional coating creates one type of roughness and irregularity described by correlations 1 and 2 and depicted in the FIGURE. The amount of material, added at the given intermediate stage, is calculated on the basis of the average number of irregularities per 1 mm² of proppant surface, their average height/depth and the length of the major axis of elliptic and other particles of non-spherical shape. According to this method, the particle formation stage is followed by traditional stages of ceramic proppant technology (drying, screening, firing, and final screening).

However, the stage of powdering, depending on the kind of the raw material used for proppant production, might be skipped for both embodiments.

Besides, the treatment of the proppant surface for development of bumpy surface might be divided into few stages making a single roughness type on every stage; this treatment follows the granule growth stage, so the stages intermitted by the powdering stage.

The adhesion between the roughness elements and the particle surface created by any of the listed procedures can be reinforced by different tackifying agents. These tackifying substances can be applied:
on particles as a fine coating followed by the roughness-depositing stage;
mixed preliminary with particulate for roughness and irregularities;
as a combination of these two approaches.

The granules before the firing stage may be reinforced by additional coating: ceramic, glass, polymer, metallic, glass or binding materials and combinations thereof.

In the standard technology for proppant production (this includes the firing stage), the firing temperature must provide the completion of phase transitions to achieve the desired density and strength of particles. The firing temperature must be enough for complete or partial flashing of the ceramic surface; the latter process causes the partial deformation of granule surface.

At the granulation stage (between the growth stage and the powdering stage), a coating with the melting point below the sintering temperature of the main granule can be deposited on the semi-finished granules. This easy-melting layer keeps tightly the roughness-making particulate on the surface of the ready granules.

The same goal can be achieved by applying of powdering agent with the melting temperature below the melting temperature of the granule body.

In yet another respect, the proppant manufacturing method includes additional stage between firing and fractional classification: proppant particle are mixed with ceramic, polymeric, metallic, glass, cement materials and compositions thereof (these materials may be in the form of powder, granules, fibers, or combinations thereof), or various agglomerates of ceramic, polymeric, metallic, glass, cement powders and/or fibers, and also their combinations; these materials stick to the proppant and create at least one type of roughness and irregularities, described by formulas 1 and 2 and depicted in the FIGURE. Thereby the amount of material, added at the intermediate stage, is calculated on the basis of the average number of irregularities upon 1 mm² of proppant surface, the average height of irregularities and proppant diameter (for spheroids).

The produced proppant is used by the standard technology of hydraulic fracturing.

In particular, the advantage of the developed proppant was tested at a well cluster, i.e., under identical conditions.

1. The hydrofracturing was carried out in the West Siberia oilfields at the depth of 3700 m under typical conditions with the expected productivity of 80-140 m³ per day. The pumping of traditional spherical ceramic proppant (smooth surface) resulted in the well production rate 90 m³ per day.

2. Under the same conditions and same proppant composition, but with artificially rough surface (described by the first criterion in our formula), the hydrofracturing resulted in the well rate about 117 m³ per day with the expected productivity range 80-140 M³ per day.

The use of the developed proppant instead of the smooth-surface proppant makes the well rate higher by approximately 30% under other conditions being identical.

We claim:

1. A proppant material comprising a particulate with spherical or elliptic form, made of ceramic, polymer, metal, or glass and having higher roughness than regular proppant, wherein the surface roughness is nonuniform and described by two criteria A and B, varying in the intervals: A=0.0085−0.85; B=0.001−1.0.

2. A method for proppant manufacturing comprising the preparation of raw material, mixing, granulation, drying, firing, wherein an additional stage of creation of surface roughness is added at the granulation stage and/or the firing stage.

3. The method of claim 2, wherein ceramic, polymer, metallic, glass, cement materials or mixtures thereof are added to a pelletizer before the granulation stage.

4. The method of claim 3, wherein powder, granules or fibers and their combinations, or various agglomerates of ceramic, polymer, metallic, glass, and cement powders and/or fibers and mixtures thereof are the raw material.

5. The method of claim 2, wherein the roughness-producing treatment is carried out in several stages, thereby these stages are intermitted by a powdering stage.

6. The method of claim 5, wherein various forms of roughness and irregularities are created at different stages after the granule growth stage.

7. The method of claim 2, wherein the tackifying agent is additionally used for higher adhesion between roughness particulate and the granule surface.

8. The method of claim 7, wherein the tackifying agent is deposited as a thin layer on the granules before the roughness stage and/or it is mixed with particulate for making roughness.

9. The method of claim 2, wherein the strengthening ceramic, glass, polymer, metallic, cement coating or mixture thereof is deposited on the particles before the firing stage.

10. The method of claim 2, wherein the firing stage has the temperature high enough for partial flashing of ceramic surface and buckling of surface during the firing stage.

11. The method of claim 2, wherein an additional layer is deposited on the granule with the melting temperature below the melting temperature of basic material of granule.

12. The method of claim 2, wherein the powdering of the semi-finished granule during the granulation stage is carried out with a powder with the melting temperature below the melting temperature of basic material of granule.

13. The method of claim 2, wherein the firing stage is followed by adding of ceramic, polymeric, metallic, glass, cement powders and/or fibers or mixtures thereof; the said materials stick to proppant and create at least one form of roughness and irregularities.
